(19) United States
(12) Patent Application Publication
(10) Pub. No.: US 2010/0225067 A1
(43) Pub. Date: Sep. 9, 2010

(54) COATED RING SEAL

(75) Inventor: GEORGE E. BAILEY, FLORESVILLE, TX (US)

Correspondence Address: VIVACQUA LAW, PLLC, 455 East Eisenhower Parkway, Suite 200, ANN ARBOR, MI, 48108, US

(73) Assignee: GM GLOBAL TECHNOLOGY OPERATIONS, INC., DETROIT, MI (US)

(21) Appl. No.: 12/399,380

(22) Filed: Mar. 6, 2009

(51) Int. Cl. F16J 15/16

(52) U.S. Cl. 277/579

(57) ABSTRACT

A ring seal includes an annular body having a first side surface, a second side surface opposite the first side surface, a top surface, and a bottom surface opposite the top surface. A coating of silica particles is disposed on at least one of the first side surface, the second side surface, the top surface, and the bottom surface of the annular body. The coating of silica particles includes a composition comprising diatomaceous earth.

### FIELD

The present disclosure relates to ring seals, and more particularly to a ring seal coated with diatomaceous earth.

### BACKGROUND

The statements in this section merely provide background information related to the present disclosure and may not constitute prior art.

There are many applications where a seal is required between a rotating component and a stationary component in order to isolate fluids at different pressures across the length of the components. These applications often include power shifting transmissions and engines in motor vehicles. Typically, a ring seal or shaft seal is used to seal the rotating component to the stationary component in order to keep the fluids on either side of the ring seal from escaping to the other side. Depending on the application, either the shaft or the bore it runs in may be the rotating component. The case of a rotating bore and stationary shaft is described herein, but the opposite case is completely analogous. The ring seal typically fits around the stationary component and has an outer surface that engages the surface of the rotating component. These conventional ring seals operate by using the pressure differential that is maintained across the length of the shaft. More specifically, the fluid in the section at higher pressure pushes the ring seal axially towards the lower pressure section, and also pushes the seal radially outward. The geometry of the seal is designed so that the radial pressure causes the seal to rotate with the bore, and a differential speed occurs on the face of the seal engaged with the stationary component.

These ring seals are typically made from a polymer, and the pressure differential applied to these ring seals can cause deformation of the ring seal. This deformation may cause a distribution of contact pressure at the face of the ring seal. The deformation decreases the durability of the ring seal and can increase the leakage of fluids across the face. Leakage in turn leads to extra power requirements from the fluid supply to compensate for the lost flow. Finally, higher pressure contact areas along the ring seal can increase friction which requires extra power to rotate the shaft. Accordingly, there is room in the art for an improved ring seal between two components that increases the durability of the ring seal surfaces, lowers friction between the components, and reduces fluid flow across the face of the seal.

### SUMMARY

A ring seal is provided and includes an annular body having a first side surface, a second side surface opposite the first side surface, a top surface, and a bottom surface opposite the top surface. A coating of silica particles is disposed on at least one of the first side surface, the second side surface, the top surface, and the bottom surface of the annular body.

In one aspect of the present invention the coating of silica particles comprises diatomaceous earth.

In another aspect of the present invention, the diatomaceous earth includes diatoms selected from a group consisting of substantially disc shaped diatoms, substantially pill box shaped diatoms, substantially elongated shaped diatoms, and combinations thereof.

In yet another aspect of the present invention, the diatomaceous earth comprises heat treated diatomaceous earth.

In yet another aspect of the present invention, the coating of silica particles is located on both the first side surface and the second side surface.

In yet another aspect of the present invention, the coating of silica particles is at least partially embedded within the annular body.

In yet another aspect of the present invention, the annular body comprises at least one of a polytetrafluoroethylene, a polyetheretherketone, and a polymide.

In yet another aspect of the present invention, the annular body is substantially rectangular in cross-section and the first side surface and the second side surface are parallel to one another, and wherein the coating of silica particles is disposed across substantially all of at least one of the first side surface and the second side surface.

In yet another aspect of the present invention, the annular body has a substantially rectangular cross-section, the top surface is an outer circumferential surface of the annular body, the bottom surface is an inner circumferential surface of the annular body, the first side surface is disposed between the top surface and the bottom surface, the second side surface is disposed between the top surface and the bottom surface, and the first side surface is parallel to the second side surface.

In yet another aspect of the present invention, the coating of silica particles is located on whichever of the first side surface and the second side surface that is exposed to a lower fluid pressure.

In yet another aspect of the present invention, the coating of silica particles comprises from about 5% to about 50% of silica particles and from about 50% to about 95% of a polymer selected from the group consisting of a polytetrafluoroethylene, a polyetheretherketone, and a polymide.

In yet another aspect of the present invention, a gradient in the concentration of the silica particles exists where the concentration on the surface is high and the concentration diminishes as the depth into the seal increases.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a front view of an embodiment of a ring seal according to the principles of the present invention;

FIG. 2 is an enlarged cross-sectional view taken in the direction of arrows 2-2 of the ring seal of FIG. 1 according to the principles of the present invention;

FIG. 3A is a cross-sectional view of the ring seal of the present invention in a first position between two exemplary components;

FIG. 3B is a cross-sectional view of the ring seal of the present invention in a second position between two exemplary components;

FIG. 4A is a cross-sectional of another embodiment of a ring seal according to the principles of the present invention; and

FIG. 4B is a cross-sectional of yet another embodiment of a ring seal according to the principles of the present invention.

### DETAILED DESCRIPTION

The following description is merely exemplary in nature and is not intended to limit the present disclosure, application, or uses.

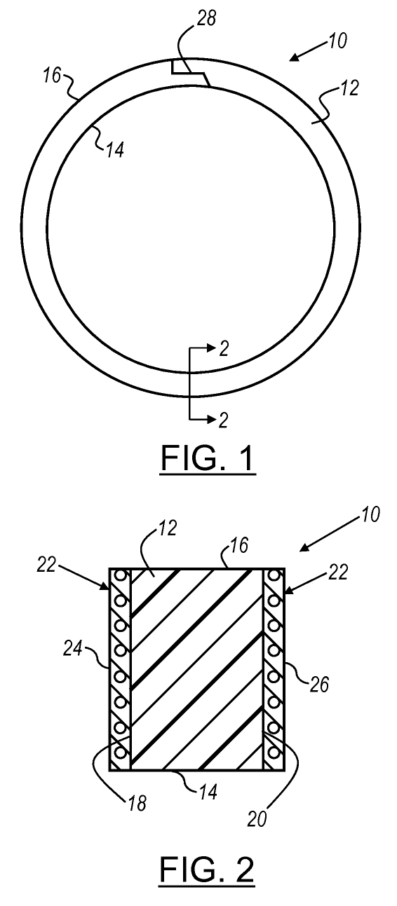

With reference to FIGS. 1 and 2, a ring seal 10 according to the principles of the present invention is generally indicated by reference number 10. The ring seal 10 includes an annular body 12. The annular body 12 is generally annular or circular with a rectangular cross section. It should be appreciated, however, that the ring seal 12 may have other cross-sectional shapes, such as a square cross-section or non-regular cross section, without departing from the scope of the present invention. The annular body 12 is preferably comprised of a polymer. Exemplary polymers for use with the present invention include, but are not limited to, polytetrafluoroethylenes, polyetheretherketones, and polymides. Other suitable materials for use with the annular body 12 include glass-filled plastics and metals. The annular body 12 includes an inner surface 14 that extends along an inner circumference of the annular body 12 and an outer surface 16 that extends along an outer circumference of the annular body 12. The annular body 12 also includes a first side surface 18 and a second side surface 20 disposed opposite the first side surface 18.

The ring seal 10 further includes a coating of a friction modifying material, indicated generally by reference number 22. In the example provided, the coating of the friction modifying material 22 is disposed on the first side surface 18 of the annular member 12 and on the second side surface 20 of the annular member 12. Accordingly, the coating of the friction modifying material 22 forms a first face 24 that covers the first side surface 18 and forms a second face 26 that covers the second side surface 20. Alternate locations of the coating of the friction modifying material 22 are described below.

The coating of friction modifying material 22 is comprised of a composition that includes silica particles. In a preferred embodiment, the coating 22 is a composition that comprises diatomaceous earth. An exemplary composition of diatomaceous earth generally includes 86% silica, 5% sodium, 3% magnesium and 2% iron. The diatomaceous earth consists of fossilized remains of diatoms, a type of hard-shelled algae. The diatomaceous earth may be of the freshwater and/or saltwater varieties without departing from the scope of the present invention. Exemplary types of diatomaceous earth that may be employed with the present invention include tripolite, bann clay, and moler. In a preferred embodiment of the present invention, the diatoms in the diatomaceous earth are disc shaped or pill box shaped or elongated or needle shaped in order to provide an effective packing of the diatomaceous earth on the first and second surfaces 18, 20. The diatomaceous earth preferably has a high thermal capacity and is stable to 1100 degrees Celsius.

The diatomaceous earth exhibits good friction properties and durability. More specifically, the microstructure of the diatomaceous earth enables fluid to flow therethrough and larger friction modifying molecules are retained by the microstructure, thereby lowering static friction. The durability is increased due to the ability of the diatoms to provide flushing of the surface, which decreases localized heating and carbonization of the fluids in contact with the ring seal 10. Exemplary diatomaceous earth suitable with the composition of the present invention are commercially available from World Minerals under the designations CELITE® and CELTIX™. In one embodiment of the present invention, the coating of diatomaceous earth comprises from about 5% to about 50% of silica particles and from about 50% to about 95% of a polymer selected from the group consisting of a polytetrafluoroethylene, a polyetheretherketone, and a polymide. In another embodiment of the present invention, a gradient in the concentration of the silica particles exists where the concentration on the surface is high and the concentration diminishes as the depth into the seal increases.

The coating of friction modifying material 22 may be applied to the annular body 12 in a number of ways. The ring seal 10 may be formed by compression molding where a layer of seal material with a high percentage of diatomaceous earth or other friction modifying material is placed at the bottom of the mold and then the mold is filled with the composition of the annular body 12. Another method includes heating the diatomaceous earth or other friction modifying material and blasting the heated diatomaceous earth with hot compressed air onto the annular body 12 such that the diatomaceous earth particles locally melt the polymer of the annular body 12 and become embedded therein. Another method includes spraying a coating of the friction modifying material on the die of an injection molding machine (in a manner similar to a mold release compound used in the art) and then injecting the polymer of the annular body 12. In yet another method, a coating of the friction modifying material is directly sprayed onto the surface or surfaces of the formed annular body 12.

The ring seal 10 optionally includes a step joint 28 that extends through the coating of friction modifying material 22 and the annular body 12. The step joint 28 allows the ring seal 10 to expand to maintain its sealing characteristics.

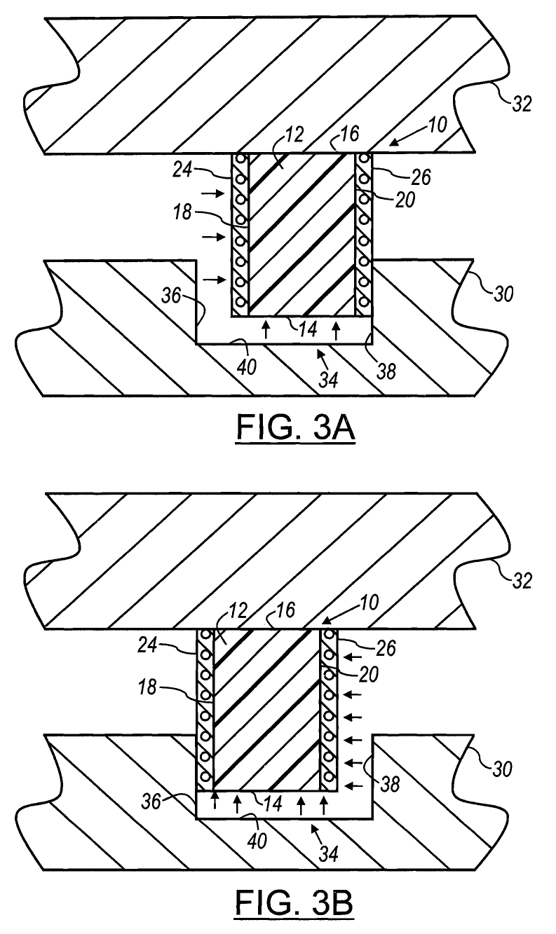

Turning now to FIG. 3A, the ring seal 10 is illustrated in use with an exemplary first component 30 and an exemplary second component 32. The first component includes a groove 34 formed therein. The groove includes a first wall 36, a second wall 38 opposite the first wall 36, and a base 40 extending between the first wall 36 and the second wall 38. The groove 34 has a width greater than a width of the ring seal 10.

The first component 30 and the second component 32 are positioned proximate to each other. In the particular example provided, the first component 30 is stationary and the second component 32 is rotatable with respect to the first component 30. However, it should be appreciated that either component 30, 32 may be stationary and either component 30, 32 may be moveable, whether through rotation or translation relative to one another.

The ring seal 10 is disposed between the first component 30 and the second component 32 such that the annular body 12 extends at least partially within the groove 34. The outer surface 16 of the annular body 12 is in contact with the second component 32. This contact between the outer surface 16 and the second component 32 acts as a seal and limits fluid from passing between the outer surface 16 and the second component 32. The outer surface 16 is preferably smooth to allow some rotation of the second component 32 with respect to the ring seal 10.

The ring seal 10 is moveable between a first position, illustrated in FIG. 3A, and a second position, illustrated in FIG. 3B. Specifically, pressurized fluid (indicated by the arrows) on either side of the ring seal 10 acts on the ring seal 10. When there is a sufficiently large pressure differential between the fluid on either side of the ring seal 10, the ring seal 10 transitions within the groove 34 and contacts one of the walls 36, 38 to limit fluid from passing between the ring seal 10 and the first component 30.

In the first position shown in FIG. 3A, fluid pressure (indicated by the arrows) contacts the ring seal 10 and exerts a fluid pressure on the first face 24. The fluid pressure force moves the ring seal 10 within the groove 34 such that the second face 26 of the ring seal 10 contacts the second wall 38 of the groove 34. This contact acts as a seal and limits fluid from passing between the second face 26 of the ring seal 10 and the second wall 38 of the groove 34. The coating of friction modifying material 22 acts to prevent deformation of the ring seal 10 and reduces localized frictional forces.

In the second position shown in FIG. 3B, fluid pressure (indicated by the arrows) contacts the ring seal 10 and exerts a fluid pressure on the second face 26. The fluid pressure force moves the ring seal 10 within the groove 34 such that the first face 24 of the ring seal 10 contacts the first wall 36 of the groove 34. This contact acts as a seal and limits fluid from passing between the first face 24 of the ring seal 10 and the first wall 36 of the groove 34. Again, the coating of friction modifying material 22 acts to prevent deformation of the ring seal 10 and reduces localized frictional forces.

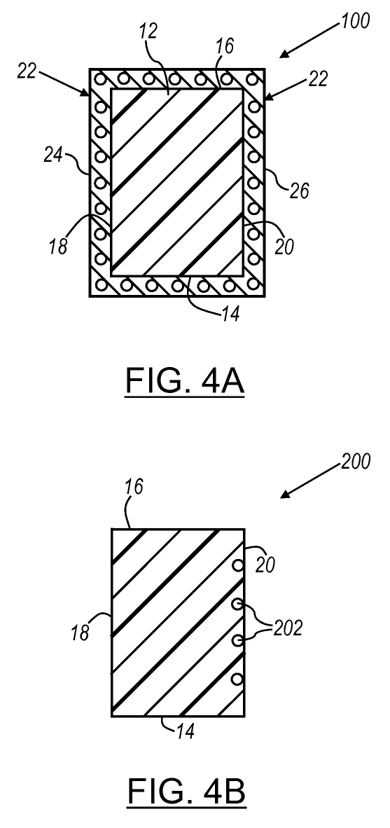

Turning now to FIG. 4A, another embodiment of a ring seal according to the principles of the present invention is indicated by reference number 100. The ring seal 100 is similar to the ring seal 10 shown in FIGS. 1-3B, however, the coating of friction modifying material 22 is located on all surfaces of the annular body 12 including the bottom surface 14, the top surface 16, the first side surface 18, and the second side surface 20. Other locations for the coating of the friction modifying material 22 not specifically shown but within the scope of the present invention includes partially or completely coating one or a combination of two or more of the surfaces 14, 16, 18, and 20 of the annular body 12. In the embodiment where only one side surface 18, 20 is coated, the side surface 18, 20 that is coated is preferably the side surface 18, 20 that seals to the first component 30.

Turning now to FIG. 4B, another embodiment of a ring seal according to the principles of the present invention is indicated by reference number 200. The ring seal 200 is similar to the ring seal 10 shown in FIGS. 1-3B, however, the ring seal 200 includes diatomaceous earth 202 that is heated and embedded into the second side surface 20 of the annular body 12. It should be appreciated that the heated diatomaceous earth 202 may be applied to any combination of surfaces 14, 16, 18, and 20 of the annular body 12 without departing from the scope of the present invention.

The coating of friction modifying material 22 on the annular body 12 increases the thickness of the fluid layer between the ring seal 10 and the components 30 and 32. This in turn lowers the operating temperature and friction compared to prior art seals. The improved thermal effects as well as increased surface hardness results in less deformation of the ring seal 10, thereby improving the sealing function of the ring seal 10. The increased surface hardness also increases the resistance against any wear particles that may be present in the fluid from embedding into the ring seal 10.

The description of the invention is merely exemplary in nature and variations that do not depart from the gist of the invention are intended to be within the scope of the invention. Such variations are not to be regarded as a departure from the spirit and scope of the invention.

What is claimed is:

1. A ring seal comprising:
an annular body having a first side surface, a second side surface opposite the first side surface, a top surface, and a bottom surface opposite the top surface; and
a coating of silica particles disposed on at least one of the first side surface, the second side surface, the top surface, and the bottom surface of the annular body.

2. The ring seal of claim 1 wherein the coating of silica particles comprises diatomaceous earth.

3. The ring seal of claim 2 wherein the diatomaceous earth includes diatoms selected from a group consisting of substantially disc shaped diatoms, substantially pill box shaped diatoms, substantially elongated diatoms, and combinations thereof.

4. The ring seal of claim 2 wherein the diatomaceous earth comprises heat treated diatomaceous earth.

5. The ring seal of claim 1 wherein the coating of silica particles is located on both the first side surface and the second side surface.

6. The ring seal of claim 1 wherein the coating of silica particles is at least partially embedded within the annular body.

7. The ring seal of claim 1 wherein the annular body comprises at least one of a polytetrafluoroethylene, a polyetheretherketone, and a polymide.

8. The ring seal of claim 1 wherein the annular body is substantially rectangular in cross-section and the first side surface and the second side surface are parallel to one another, and wherein the coating of silica particles is disposed across substantially all of at least one of the first side surface and the second side surface.

9. The ring seal of claim 1 wherein the annular body has a substantially rectangular cross-section, the top surface is an outer circumferential surface of the annular body, the bottom surface is an inner circumferential surface of the annular body, the first side surface is disposed between the top surface and the bottom surface, the second side surface is disposed between the top surface and the bottom surface, and the first side surface is parallel to the second side surface.

10. The ring seal of claim 9 wherein the coating of silica particles is located on whichever of the first side surface and the second side surface that is exposed to a lower fluid pressure.

11. The ring seal of claim 1 wherein the coating of silica particles comprises from about 5% to about 50% of silica particles and from about 50% to about 95% of a polymer selected from the group consisting of a polytetrafluoroethylene, a polyetheretherketone, and a polymide.

12. The ring seal of claim 11 wherein a concentration of the silica particles diminishes as the depth into the seal increases.

13. A ring seal for sealing between a first component and a second component, the first component having a groove formed therein, the groove having a first wall and a second wall, the ring seal comprising:
an annular body at least partially disposed within the groove, the annular body having:
a first side surface;
a second side surface opposite the first side surface, wherein the second side surface is configured to selectively contact the second wall of the groove;
a first surface in contact with the second component; and
a second surface opposite the first surface; and
a coating of diatomaceous earth disposed on the first side surface to form a first face surface, wherein the first face surface is configured to selectively contact the first wall of the groove, and
whereby a pressure acting on the second side surface of the annular body forces the first face surface to contact the first wall of the groove.

14. The ring seal of claim 13 further comprising a coating of diatomaceous earth disposed on the second side surface to form a second face surface, wherein the second face surface is configured to selectively contact the second wall of the groove, and whereby a pressure acting on the first face surface forces the second face surface to contact the second wall of the groove.

15. The ring seal of claim 13 wherein the coating of diatomaceous earth includes diatoms selected from a group consisting of substantially disc shaped diatoms, substantially pill box shaped diatoms, substantially elongated diatoms, and combinations thereof.

16. The ring seal of claim 13 wherein the coating of diatomaceous earth comprises heat treated diatomaceous earth.

17. The ring seal of claim 13 wherein the coating of diatomaceous earth is at least partially embedded within the first side surface of the annular body.

18. The ring seal of claim 13 wherein the annular body comprises at least one of a polytetrafluoroethylene, a polyetheretherketone, and a polymide.

19. The ring seal of claim 13 wherein the coating of diatomaceous earth comprises from about 5% to about 50% of diatomaceous earth and from about 50% to about 95% of a polymer selected from the group consisting of a polytetrafluoroethylene, a polyetheretherketone, and a polymide.
